(19) United States
(12) Patent Application Publication
(10) Pub. No.: US 2009/0083585 A1
(43) Pub. Date: Mar. 26, 2009

(54) METHOD OF PRESSURE TESTING FOR PERIPHERAL COMPONENT INTERCONNECT (PCI) BUS STAGE

(75) Inventors: Tao LIU, Tianjin (CN); Qiu-Yue DUAN, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 11/858,960

(22) Filed: Sep. 21, 2007

(51) Int. Cl. G06F 11/00

(52) U.S. Cl. 714/43; 714/E11.002

(57) ABSTRACT

A method of pressure testing for peripheral component interconnect (PCI) bus stage that is used in the overall pressure testing of PCI bus. The method includes the steps of reviewing all the PCI buses in a system; obtaining a tree-shaped structure of the all the PCI buses and PCI devices of the entire system, and selecting from them a branch of PCI bus as an object of testing; performing peripheral component interconnect function test, input/output function test, and memory mapping function test of the PCI bus relative to this object of testing; and selecting a branch of PCI bus from among the remaining branches of PCI buses of the system as an object of testing to proceed with the related tests of PCI bus mentioned above, until all the branches of PCI buses to be tested have finished testing.

### FIELD OF INVENTION

The invention relates to a bus pressure testing method, and in particular to a pressure testing method for peripheral component interconnect (PCI) bus stage.

### RELATED ART

In general, PCI bus is one of the basic and fundamental buses of a system, thus, the functions and capability of PCI bus will affect directly the overall functions and capability of a system. Therefore, the test of PCI bus is essential to the overall function and capability test of a system. However, in actual application, the PCI bus pressure test itself is subject to the restrictions of certain factors, such as review redundancy and test instruments. Thus, how to thoroughly and effectively carry out the test of PCI bus has become a difficult problem that has yet to be solved in the functional test of a system.

The major disadvantages of the conventional pressure tests of PCI buses are as follows:
(1) In most of the conventional pressure tests, the emphases are on testing a single and individual device on a main-board, such as Universal Serial Bus (USB), Network Interface Card (NIC), etc. However, the pressure test of the entire and overall PCI Bus is lacking;
(2) In the conventional pressure test, the test of PCI bus is realized through testing hardware by making use of software. For example, in the test of PCI bus, the PCI Test Card is utilized. As such, the functions and operations of PCI test cards are realized through the functions and operations of software of upper level, thus the error detection of PCI bus is achieved by making use of the feedback information. As such, the essence of this approach is that, the testing of hardware is realized through the operation of software. Namely, the conventional test would require the support of special test instrument, thus it can not be applied to all types of systems, and the scope of test is very much limited;
(3) The conventional test approach is not capable of achieving testing each of the respective PCI buses, thus its test coverage is not wide enough;
(4) The time required for a conventional test approach is rather too long. For example, in the test of transmission capability of the bus, it could even require as long as 10 minutes to complete;
(5) The various test approaches under different Operation System (OS) are quite different and not unified, thus program compatibility is not adequate;
(6) In implementing the Direct Memory Access (DMA) data transmission test of PCI, a rather large and continuous physical memory has to be allocated for the related Operation System (OS). Presently, due to the fact that, such a large and continuous physical memory can not be allocated for an OS due to its design restrictions, hereby making the range of coverage and test pressure of the present DMA transmission test fall far short of the test requirement of hardware; and
(7) The pressure test design and solution for PCI equipment under Extensible Firmware Interface (EFI) is lacking.

### SUMMARY OF THE INVENTION

In view of the above-mentioned drawbacks and shortcomings of the prior art, the objective of the invention is to provide a method of pressure testing for peripheral component interconnect (PCI) bus stage, wherein, the entire PCI bus is pressure-tested.

The invention provides a method of pressure testing for peripheral component interconnect (PCI) bus stage, comprising the following steps: reviewing all the PCI buses in a system; obtaining a tree-shaped structure of the overall PCI buses and PCI devices of the system, and selecting from them a branch of PCI bus as an object of testing; performing peripheral component interconnect function test, input/output function test, and memory mapping function test for the PCI bus relative to this object of testing; and determining if there are still other branches of PCI bus to be tested in the system. If the answer if affirmative, then continuing selecting a branch of PCI bus as an object of testing to proceed with the PCI function test, input/output function test, and memory mapping function test, of a PCI bus until all the branches of PCI bus to be tested have finished testing; otherwise, terminating the test.

In the method of pressure testing for peripheral component interconnect (PCI) bus stage of the invention, the step of obtaining a tree-shaped structure of the overall PCI buses and PCI devices of a system further includes the following steps: (a) reviewing and recording all the PCI devices and PCI bridges on PCI bus 0; (b) selecting a PCI bridge and obtaining a PCI space of this PCI bridge, analyzing this PCI space to obtain a PCI bus of the next stage connected to this PCI bridge, and the maximum bus depth that can be reached by this PCI bridge; (c) determining if PCI bus of next stage has reached the maximum bus depth of this PCI bridge, and if the answer if negative, positioning to and reviewing the PCI bus of next stage, hereby obtaining and recording all the PCI devices and PCI bridges on that PCI bus, and then proceeding with step (b); (d) if the answer if affirmative, determining if there exist other PCI bridges on the present PCI bus, if the answer if affirmative, then proceeding with step (b); and (e) otherwise, the answer if negative, then determining if the present PCI bus is PCI bus 0; if it is, then storing the reviewing results, thus obtaining a tree-shaped structure of all the PCI buses and PCI devices of the entire system, otherwise returning to the former stage of PCI bus and executing step (d).

In the method of pressure testing for peripheral component interconnect (PCI) Bus stage of the invention, the step of selecting a branch of PCI bus as an object of testing to proceed with the peripheral component interconnect function test of PCI bus, further includes the following steps:

Reviewing all the devices attached under this branch of PCI bus, and examining to see if the nth device attached under this branch of PCI bus can be accessed normally, if the answer is negative, then reporting the error and exiting the test; otherwise, examining to see if the space allocated to a standard header of the nth device attached under this branch of PCI bus can be accessed normally, if the answer is negative, then reporting the error and exiting the test; otherwise, analyzing the contents of the space allocated to a standard header thus obtained, and verifying to see if each item of the respective data information of the nth device attached under this branch of PCI bus can be successfully fetched and obtained, if the answer is negative, then reporting the error and exiting the test; otherwise, detecting to see if the space allocated to the device related component of the nth device attached under this branch of PCI bus can be accessed normally, if the answer is negative, then reporting the error and exiting the test; otherwise, determining to see if there exists an (n+1) device attached under this branch of PCI bus, and if the answer if negative, then ending and exiting the test, otherwise, returning to the (n+1) device attached under this branch of PCI bus, and continuing the testing until all the devices attached under this branch of PCI bus have finished testing.

In the method of pressure testing for peripheral component interconnect (PCI) bus stage of the invention, the step of selecting a branch of PCI bus as an object of testing to proceed with the input/output function test of PCI bus, further includes the following steps:

Detecting to see if the object of testing is capable of supporting the input/output mapping function, if the answer is affirmative, then obtaining the various addresses of the input/output spaces mapped by the object of testing; reading and storing the data of the nth input/output space mapped by the present object of testing, and transmitting data to the nth input/output space, then reading the data of the nth input/output space; verifying to see if the read out data is identical to the transmitted data, if the answer is negative, then reporting the error and exiting the test, otherwise, negating the data to be transmitted in a bitwise manner and transmitting them to the nth input/output space, then reading the data in the nth input/output space, and verifying it to see if the read out data is identical to the transmitted data, if the answer is negative, then reporting the error and exiting the test, otherwise, determining if all the data required to be transmitted have finished transmitting, if there are data still to be transmitted, then continuing transmitting data to the nth input/output space mapped by the object of testing; otherwise, if all the data have finished transmitting, then restoring the data of the nth input/output space mapped by the present object of testing; and determining if there still exist objects of testing in the (n+1) input/output space, if the answer if affirmative, then returning back to perform the step of reading and storing the data of the (n+1)th input/output space mapped by the present object of testing, otherwise, ending and exiting the test. In the above description, the process of verifying to see if the read out data is identical to the transmitted data is carried out in a bitwise manner.

In the method of pressure testing for peripheral component interconnect (PCI) bus stage of the invention, the step of selecting a branch of PCI bus as an object of testing to proceed with the memory mapping function test of PCI bus, further includes the following steps:

Obtaining the starting address of the physical memory space mapped by the object of testing supporting the memory mapping and mapping length, and storing the data of memory mapping area of the object of testing; allocating the system physical memory equivalent to that of the mapped physical memory, and performing the filling of test data, then performing initialization for the physical memory mapped by the object of testing, and transmitting the data of the allocated system physical memory to the physical memory mapped by the object of testing in a slave manner; reading the data of the physical memory mapped by the object of testing, and comparing it with the data of the allocated system physical memory to determine if they are the same, if the answer is negative, then reporting the error and exiting the test, otherwise, performing initialization for the physical memory mapped by the object of testing, and filling the physical memory mapped by the object of testing with test data; and finally initializing the allocated system physical memory, and transmitting the data of the physical memory mapped by the object of testing to the allocated system physical memory in a master manner, then reading the data of the allocated system physical memory, and comparing it with that of the physical memory mapped by the object of testing to see if they are identical, if the answer is affirmative, then ending the test, otherwise, reporting the error and exiting the test.

In addition, the method of pressure testing for peripheral component interconnect (PCI) bus stage of the invention can be adapted to use in the pressure testing under various different Operation Systems. Wherein, the operation system mentioned include: DOS operation system, Linux operation system, Window operation system, and EFI operation system, etc.

Summing up the above, the advantages of the invention are as follows:

The purpose of the method of pressure testing for peripheral component interconnect (PCI) bus stage of the invention is to provide a unified pressure testing solution for all the PCI buses in a system, hereby filling the gap and compensating for the shortcomings of the prior art concerning PCI bus pressure testing. Moreover, it can be utilized in the pressure testing of PCI bus in EFI environment, flexibly making use of features and advantages of EFI, thus raising the test pressure utilized significantly compared with that under other operation systems.

Meanwhile, the method of pressure testing for peripheral component interconnect (PCI) bus stage of the invention is utilized to achieve the objective of adopting the same core testing algorithm for various different operation systems, hereby taking a synthetic and all around consideration for the various operation systems, such as DOS, Windows, Linux, and EFI. In the invention, a core testing algorithm is proposed, that is adaptable to use in various operation systems, and it can be utilized to adjust the test flow flexibly and adroitly depending on the characteristics of various operation systems. Besides, in the invention, the test can be carried out without having to rely on any test instrument, thus eliminating the requirement and restriction of test instrument, and is suitable to use in various types of systems.

In addition, the core testing algorithm of the invention has taken into consideration of the requirements of system from all the three aspects of peripheral component interconnect function test, input/output function test, and memory mapping function test, thus raising the completeness and integrity of the pressure testing; meanwhile its test strategy also taking into account of the various aspects such as test pressure and test time required, hereby saving the testing time required and raising the test pressure utilized.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus are not limitative of the present invention, and wherein:

FIG. 1 is a complete flowchart of the steps of a method of pressure testing for peripheral component interconnect (PCI) bus stage of the invention;

FIG. 2 is a flowchart of the steps of obtaining a tree-shaped structure of all the PCI buses and PCI devices of an entire system in a method of pressure testing for peripheral component interconnect (PCI) bus stage of the invention;

FIG. 3 is a flowchart of the steps of peripheral component interconnect function test of PCI bus of the invention;

FIG. 4 is a flowchart of the steps of input/output function test of PCI bus of the invention; and

FIG. 5 is a flowchart of the steps of memory mapping function test of PCI bus of the invention.

### DETAILED DESCRIPTION OF THE INVENTION

The purpose, construction, features, and functions of the invention can be appreciated and understood more thoroughly through the following detailed description with reference to the attached drawings.

In the following, the preferred embodiments of the invention will be described in detail together with the attached drawings.

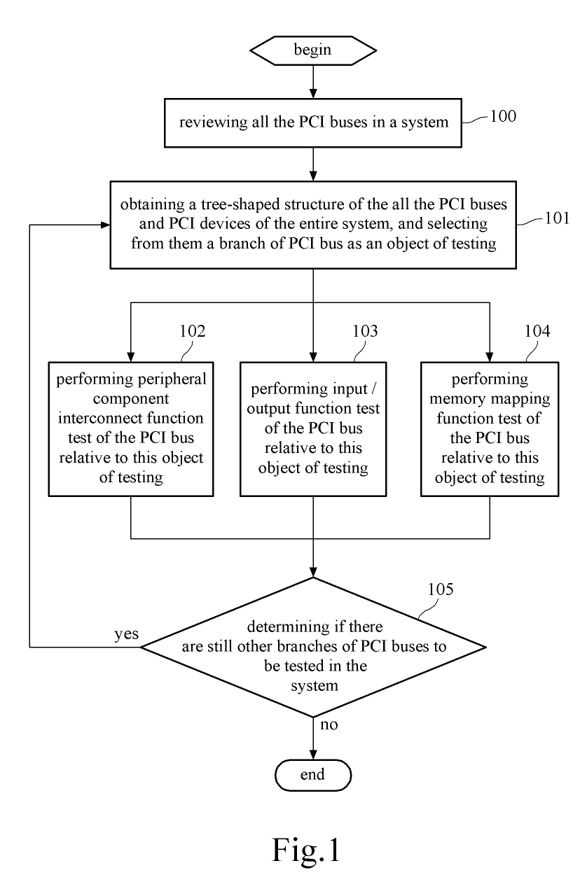

Refer to FIG. 1 for a complete flowchart of a method of pressure testing for peripheral component interconnect (PCI) bus stage of the invention. As shown in FIG. 1, the method of pressure testing for peripheral component interconnect (PCI) bus stage of the invention includes the following steps: firstly, reviewing all the PCI buses in a system (step 100); obtaining a tree-shaped structure of the entire PCI buses of the system, and selecting from them a branch of PCI bus as an object of testing (step 101); performing peripheral component interconnect function test of the PCI bus relative to this object of testing (step 102), wherein, determining to see if there are any problems discovered during the function test (not shown), if the answer if affirmative, reporting the error and exiting the test, otherwise, determining if the object of testing is capable of supporting the input/output mapping function (not shown), if the answer if negative, then selecting the next object of testing to perform the related test, otherwise, performing the function test relative to the object of testing by employing the input/output function test of the PCI bus (step 103), wherein, determining to see if there are any problems discovered during the function test (not shown), if the answer if affirmative, reporting the error and exiting the test, otherwise, determining to see if the object of testing is capable of supporting the memory mapping function (not shown), if the answer if negative, then selecting the next object of testing to perform the related test, otherwise, performing the function test relative to the object of testing by employing the memory mapping function test of the PCI bus (step 104), wherein, determining to see if there are any problems discovered during the function test (not shown), if the answer if affirmative, reporting the error and exiting the test, otherwise, determining to see if there are branches of PCI bus in the system that have yet to be tested (step 105), if the answer if affirmative, then returning back to perform step 101, thus continuing selecting another branch of PCI bus as an object of testing to perform the peripheral component interconnect function test, input/output function test, and memory mapping function test of PCI bus, until all the branches of PCI bus that have yet to be tested have finished testing, otherwise, ending the entire test.

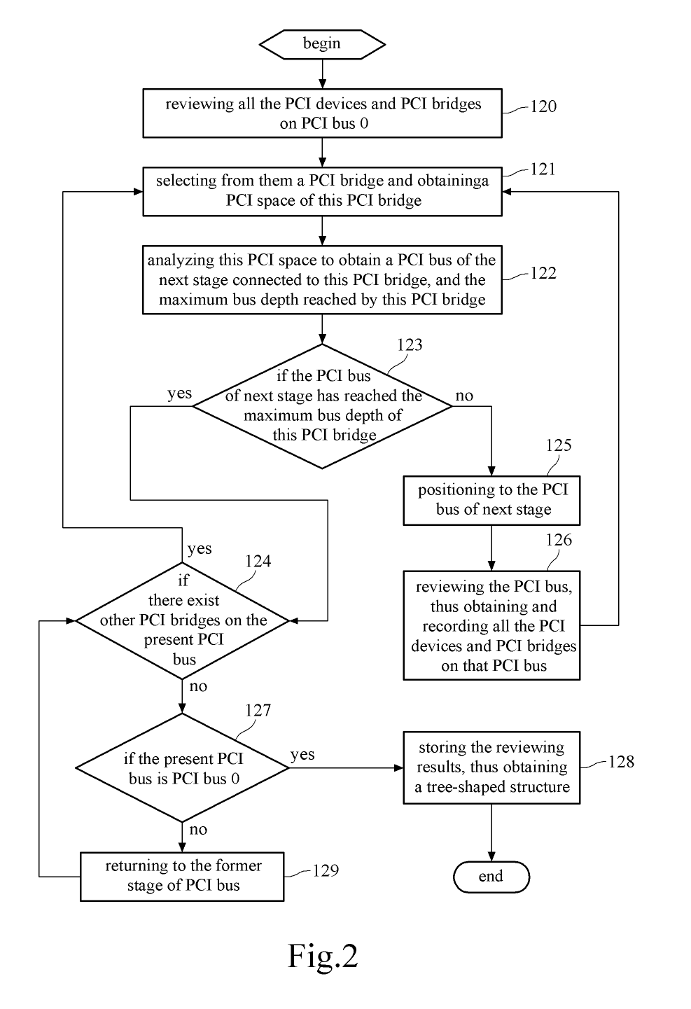

Referring now to FIG. 2, for a flowchart of the steps of obtaining a tree-shaped structure of PCI bus and PCI devices of a system in a method of pressure testing for peripheral component interconnect (PCI) bus stage of the invention. As shown in FIG. 2, the step of obtaining a tree-shaped structure of all the PCI buses and PCI devices of a system in the invention further includes the following steps of: reviewing and recording all the PCI devices and PCI bridges on PCI bus 0 (step 120); selecting a PCI bridge and obtaining a PCI space of this PCI bridge (step 121), analyzing this PCI space to obtain a PCI bus of the next stage connected to this PCI bridge, and the maximum bus depth that can be reached by this PCI bridge (step 122); determining if PCI bus of next stage has reached the maximum bus depth of this PCI bridge (step 123), if the answer if negative, then positioning to the PCI bus of next stage (step 125), reviewing the PCI bus at this stage, obtaining and recording all the PCI devices and PCI bridges on that PCI bus (step 126), then returning to proceed with step 121; if the answer if affirmative, determining if there are other PCI bridges on the present PCI bus (step 124), if the answer if affirmative, then proceeding with step 121; otherwise, determining if the present PCI bus is PCI bus 0 (step 127); if it is, then storing the reviewing results, thus obtaining the tree shaped structure of the all the PCI buses and PCI devices of the entire system (step 128), otherwise returning to the former stage of PCI bus and executing step 124.

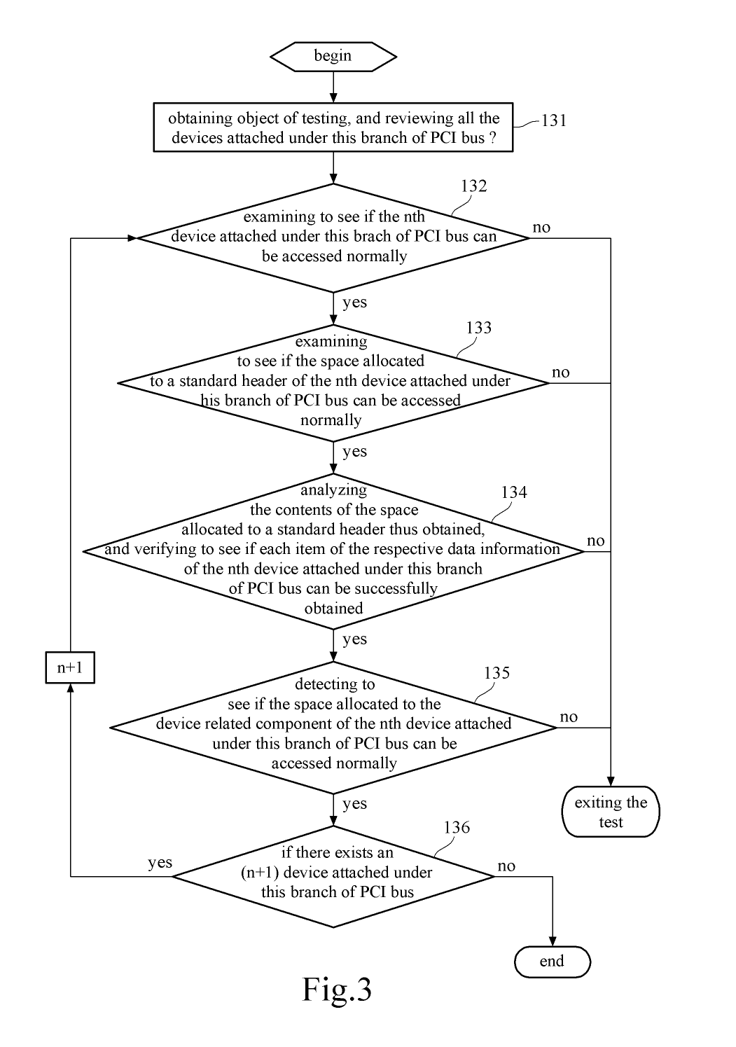

Referring now to FIG. 3 for a flowchart of the steps of peripheral component interconnect function test of PCI bus of the invention. As shown in FIG. 3, the step of peripheral component interconnect function test of PCI bus of the invention further includes the following steps:

Obtaining an object of testing (namely, a branch of a specific PCI bus), and reviewing all the devices attached under this branch of PCI bus (step 131); examining to see if the nth device attached under this branch of PCI bus can be accessed normally (step 132), if the answer is negative, then reporting the error and exiting the test; otherwise, examining to see if the space allocated to a standard header of the nth device attached under this branch of PCI bus can be accessed normally (step 133); if the answer is negative, then reporting the error and exiting the test; otherwise, analyzing the contents of the space allocated to the standard header thus obtained, and verifying to see if each item of the respective data information of the nth device attached under this branch of PCI bus can be fetched and obtained successfully (step 134); if the answer is negative, then reporting the error and exiting the test; otherwise, detecting to see if the space allocated to the device related component of the nth device attached under PCI bus can be accessed normally (step 135); if the answer is negative, then reporting the error and exiting the test; otherwise, determining to see if there exist an (n+1) device attached under this branch of PCI bus (step 136), and if the answer if negative, then ending and exiting the test, otherwise, performing step 132, and continuing the testing of the (n+1) device until all the devices attached under this branch of PCI bus have finished testing.

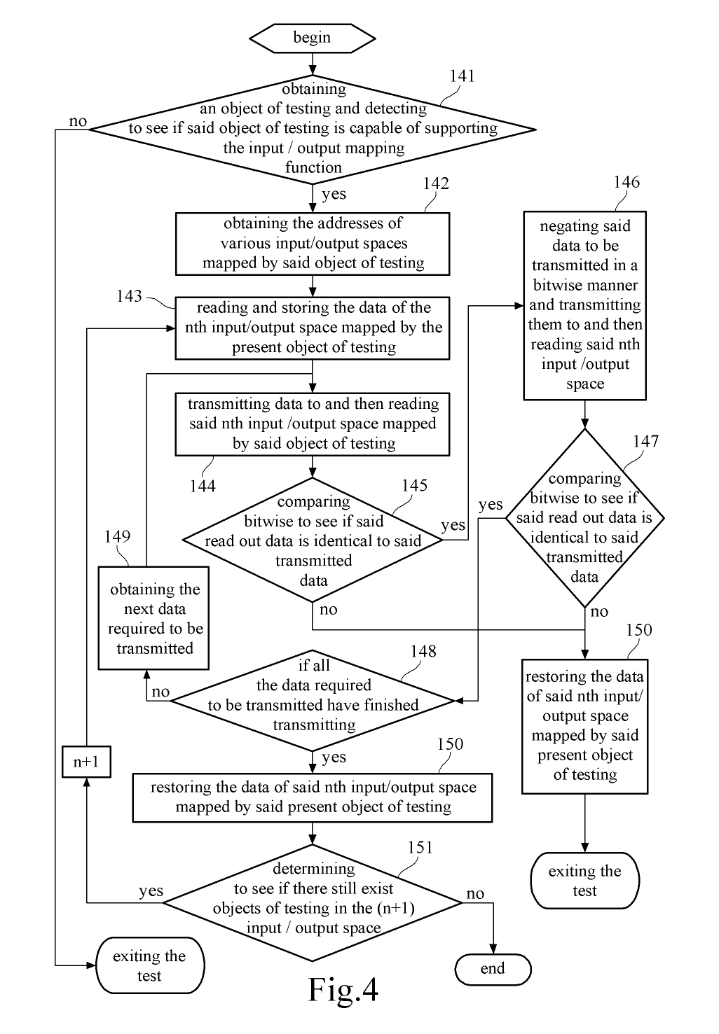

Referring now to FIG. 4 for a flowchart of the steps of input/output function test of PCI bus of the invention. As shown in FIG. 4, the step of input/output function test of PCI bus of the invention includes further the following steps:

Firstly, obtaining an object of testing (namely, a PCI device to be tested and connected to a specific branch of PCI bus), and detecting to see if the object of testing is capable of supporting the input/output mapping function (step 141); and if the answer is negative, then exiting the test, otherwise, obtaining the various addresses of the input/output spaces mapped by the object of testing (step 142); reading and storing the data of the nth input/output space mapped by the present object of testing (step 143); and transmitting test data to the nth input/output space mapped by the present object of test, and then reading the data of the nth input/output space mapped by the present object of test (step 144); comparing and verifying to see if the read out data is identical to the transmitted data (step 145); if the answer is negative, then restoring the data in the nth input/output space mapped by the present object of testing (step 150), reporting the error and exiting the test, otherwise, negating the test data to be transmitted in a bitwise manner, and transmitting the negated data to the nth input/output space mapped by the present object of testing, then reading the data in the nth input/output space mapped by the present object of testing (step 146), and comparing and verifying in a bitwise manner if the read out data and transmitted data are identical (step 147); if the answer is negative, then restoring the data in the nth input/output space mapped by the present object of testing (step 150), and reporting the error and exiting the test, otherwise, determining if all the data required to be transmitted have finished transmitting (step 148); if there are data still to be transmitted, then obtaining the next data required to be transmitted (step 149), and executing step 144; if all the data required have finished transmitting, then restoring the data in the nth input/output space mapped by the present object of testing (step 150); and determining to see if there still exist objects of testing in the (n+1) input/output space, if the answer if affirmative (step 151); if the answer is negative, then ending the test; otherwise, performing step 143 until all the input/output spaces have finished testing.

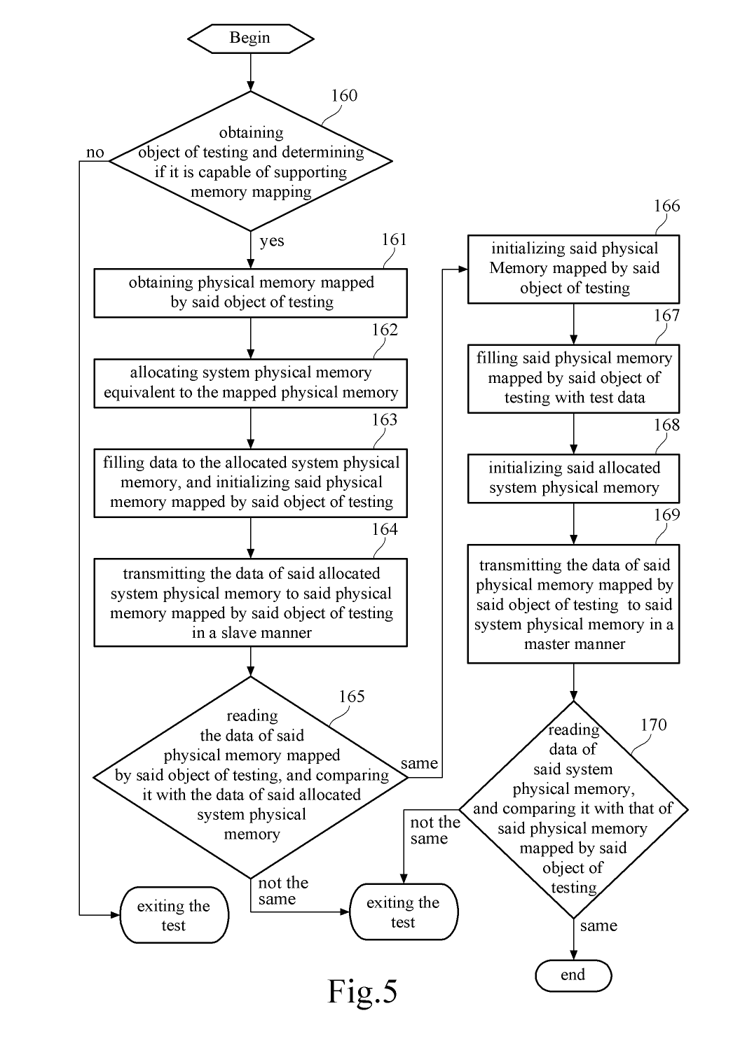

Finally, referring to FIG. 5 for a flowchart of the steps of memory mapping function test of PCI bus of the invention. As shown in FIG. 5, the step of memory mapping function test of PCI bus of the invention includes further the following steps:

Obtaining an object of testing (namely, a PCI device to be tested and connected to a branch of a certain PCI bus), and determining if the object of testing is capable of supporting the memory mapping function (step 160); if the answer if negative, then exiting the test, otherwise, obtaining the starting address of the physical memory space mapped by the object of testing and mapping length, and storing the data of memory mapping area of the object of testing (step 161); allocating the system physical memory equivalent to that of the mapped physical memory (step 162); in step 162, the block size of the allocated system physical memory are preferably the same as those of the memory space mapped by the object of testing, then filling the system physical memory with test data, initializing the physical memory mapped by the object of testing (step 163), and transmitting the data of the allocated system physical memory to physical memory mapped by the object of testing (step 164) in a slave manner, then reading the data of physical memory mapped by the object of testing, and comparing it with the data of the allocated system physical memory to determine if they are identical (step 165); if the answer is negative, then reporting the error and exiting the test, otherwise initializing physical memory mapped by the object of testing (step 166); and filling the physical memory mapped by the object of testing with test data (step 167); then initializing the allocated system physical memory (step 168); then transmitting the data of physical memory mapped by the object of testing to the allocated system physical memory in a master manner (step 169); then reading the data of the allocated system physical memory and comparing it with the data of physical memory mapped by the object of testing to see if they are identical (step 170); if the answer is negative, the reporting the error and exiting the test, otherwise, ending and finishing the test.

Summing up the above, the method of pressure testing for peripheral component interconnect (PCI) bus stage of the invention can be utilized in various operation systems in carrying out the test required, including: DOS operation system, wherein, the transmission capability test of PCI bus requires allocation of physical memory for the system, while in DOS operation system, the address of physical memory may be accessed directly; Linux operation system, wherein, the allocation and access of physical memory are achieved through increased multi-line support and the addition of an intermediate driving layer, thus realizing the pressure testing method of the invention; Windows operation system, wherein, the pressure testing method of the invention is realized through increased multi-line support and the addition of two intermediate driving layers, in which, one is used for the operation of a PCI device, and the other is used for the allocation and access of physical memory; and an EFI operation system, wherein, through direct operation of the physical memory, the transmission of large amount of data is realized by making use of continuous physical memory of the largest extent, and the test of PCI bus is achieved through the operation of a PCI driving program of the system, hereby realizing the pressure testing method of the invention, while ensuring that the test pressure of PCI bus may attain its maximum level in this EFI operation system environment.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of pressure testing for peripheral component interconnect (PCI) bus stage, that is used in the overall pressure testing of PCI bus, including the following steps:
reviewing all said PCI buses in a system;
obtaining a tree-shaped structure of all said PCI buses and PCI devices of said entire system, and selecting from them a branch of said PCI bus as an object of testing;
performing peripheral component interconnect function test, input/output function test, and memory mapping function test of said PCI bus relative to said object of testing; and
determining if there are still other branches of PCI bus to be tested in the system, if the answer if affirmative, then continuing selecting a branch of said PCI bus as an object of testing to proceed with said PCI function test, said input/output function test, and said memory mapping function test of a PCI bus, until all the branches of said PCI bus to be tested have finished testing; otherwise, terminating the test.

2. The method of pressure testing for peripheral component interconnect (PCI) bus stage as claimed in claim 1, wherein, the step of obtaining said tree-shaped structure of all said PCI buses and PCI devices of said system further includes the following steps:
(a) reviewing all said PCI devices and PCI bridges on PCI bus 0;
(b) selecting a PCI bridge and obtaining a PCI space of said PCI bridge, analyzing said PCI space to obtain a PCI bus of the next stage connected to said PCI bridge, and the maximum bus depth that can be reached by said PCI bridge;
(c) determining if said PCI bus of next stage has reached the maximum bus depth of said PCI bridge, and if the answer is negative, positioning to and reviewing said PCI bus of next stage, and obtaining and recording all said PCI devices and said PCI bridges on said PCI bus, then proceeding with step (b);
(d) if the answer if affirmative, determining if there exist other PCI bridges on the present PCI bus, if the answer if affirmative, then proceeding with step (b); and
(e) otherwise, the answer if negative, then determining if the present PCI bus is PCI bus 0;
if it is, then storing the reviewing results, thus obtaining said tree-shaped structure of the entire PCI bus and PCI devices of the system, otherwise returning to the former stage of PCI bus and executing step (d).

3. The method of pressure testing for peripheral component interconnect (PCI) bus stage as claimed in claim 1, wherein, the step of selecting a branch of PCI bus as an object of testing to proceed with the peripheral component interconnect function test, further includes the following steps:
reviewing all the devices attached under said branch of PCI bus;
examining to see if the nth device attached under said branch of PCI bus can be accessed normally, if the answer is negative, then reporting the error and exiting the test;
if said nth device can be accessed normally, then examining to see if the space allocated to a standard header of said nth device attached under said branch of PCI bus can be accessed normally, if the answer is negative, then reporting the error and exiting the test;
if said nth device can be accessed normally, then analyzing the contents of the space allocated to said standard header thus obtained, and verifying to see if each item of the respective data information of the nth device attached under said branch of PCI bus can be successfully fetched and obtained, if the answer is negative, then reporting the error and exiting the test;
if the data information can be obtained, detecting to see if the space allocated to the device related component of said nth device attached under said branch of PCI bus can be accessed normally, if the answer is negative, then reporting the error and exiting the test;
if the space allocated can be accessed normally, then determining to see if there exists an (n+1) device attached under this branch of PCI bus, and if the answer if negative, then ending and exiting the test; and
if the (n+1) device does exist, returning to said (n+1) device attached under this branch of PCI bus, and continuing the testing until all the devices attached under said branch of PCI bus have finished testing.

4. The method of pressure testing for peripheral component interconnect (PCI) bus stage as claimed in claim 1, wherein, the step of selecting a branch of PCI bus as an object of testing to proceed with the input/output function test, further includes the following steps:
detecting to see if said object of testing is capable of supporting the input/output mapping function, if the answer is affirmative, then obtaining the various addresses of the input/output spaces mapped by said object of testing;
reading and storing the data of said nth input/output space mapped by said present object of testing, and transmitting data to said nth input/output space, and then reading the data of said nth input/output space;
verifying to see if the read out data is identical to the transmitted data, if the answer is negative, then reporting the error and exiting the test, otherwise, negating the data to be transmitted in a bitwise manner and transmitting them to said nth input/output space, then reading the data in said nth input/output space, and verifying it to see if said read out data is identical to said transmitted data, and if the answer is negative, then reporting the error and exiting the test, otherwise, determining if all the data required to be transmitted have finished transmitting, if there are data still to be transmitted, then continuing transmitting data to said nth input/output space mapped by said object of testing; otherwise, if all the data have finished transmitting, then restoring the data of said nth input/output space mapped by said present object of testing; and
determining to see if there still exist objects of testing in the (n+1) input/output space, if the answer if affirmative, then returning back to perform the step of reading and storing the data of said (n+1)th input/output space mapped by said present object of testing, otherwise, ending and exiting the test.

5. The method of pressure testing for peripheral component interconnect (PCI) bus stage as claimed in claim 4, wherein,
the comparison of said transmitted data and said read out data is carried out in a bitwise manner.

6. The method of pressure testing for peripheral component interconnect (PCI) bus stage as claimed in claim 1, wherein, the step of selecting a branch of PCI bus as an object of testing to proceed with the memory mapping function test, further includes the following steps:
obtaining the starting address of the physical memory space mapped by said object of testing supporting the memory mapping, and the mapping length, and storing the data of memory mapping area of said object of testing;
allocating a system physical memory equivalent to said mapped physical memory, and performing the filling of test data, then performing initialization of said physical memory mapped by said object of testing, and transmitting the data of said allocated system physical memory to said physical memory mapped by said object of testing in a slave manner;
reading the data of said physical memory mapped by said object of testing, and comparing it with the data of said allocated system physical memory to determine if they are the same, if the answer is negative, then reporting the error and exiting the test, otherwise, performing initialization for said physical memory mapped by said object of testing, and filling said physical memory mapped by said object of testing with test data; and
initializing said allocated system physical memory, and transmitting the data of said physical memory mapped by said object of testing to said allocated system physical memory in a master manner, then reading the data of said allocated system physical memory, and comparing it with that of said physical memory mapped by said object of testing to determine if they are the same, if the answer is affirmative, then ending the test, otherwise, reporting the error and exiting the test.

7. The method of pressure testing for peripheral component interconnect (PCI) bus stage as claimed in claim 6, wherein
the block size of said allocated system physical memory is preferably of the same size as that of said physical memory mapped by said object of testing.

8. The method of pressure testing for peripheral component interconnect (PCI) bus stage as claimed in claim 1, wherein
said method can be adapted to utilize in various different operation systems, including: DOS operation system, Linux operation system, Windows operation system, and EFI (Extensible Firmware Interface) operation system.
